(19) United States
(12) Patent Application Publication
(10) Pub. No.: US 2026/0043691 A1
(43) Pub. Date: Feb. 12, 2026

(54) SENSOR ARRANGEMENT AND METHOD FOR PRODUCING A SENSOR ARRANGEMENT

(71) Applicant: TDK Electronics AG, Muenchen (DE)

(72) Inventors: Handy Setiawan, Berlin (DE); Andi Permana, Batam (ID); Tunggul Jatmiko, Batam (ID)

(21) Appl. No.: 18/896,347

(22) Filed: Sep. 25, 2024

(30) Foreign Application Priority Data
Aug. 7, 2024 (DE) 102024122526.2

(51) Int. Cl. G01K 7/16; G01K 1/14

(52) U.S. Cl. CPC G01K 7/16; G01K 1/14

(57) ABSTRACT

In an embodiment a sensor arrangement for measuring a temperature includes at least one double-sided printed circuit board, wherein the circuit board has a top side and a bottom side, at least one first solder pad and at least one second solder pad being arranged on the top side and on the bottom side, respectively, at least one sensor device mechanically and electrically connected directly to the top side of the circuit board, and an insulation enveloping at least the sensor device on the top side of the circuit board completely.

### CROSS-REFERENCE TO RELATED APPLICATIONS

This application claims to German application no. 102024122526.2, filed on Aug. 7, 2024, which application is hereby incorporated herein by reference.

### TECHNICAL FIELD

The present invention relates to a sensor arrangement, preferably a temperature sensor arrangement. The invention further relates to a method for producing a sensor arrangement, preferably a plurality of sensor arrangements.

### SUMMARY

Embodiments provide a sensor arrangement with improved properties.

According to one embodiment the sensor arrangement is adapted and arranged for measuring a temperature. The sensor arrangement is a temperature sensor arrangement. The sensor arrangement is especially adapted for measuring the temperature of a surface.

The sensor arrangement comprises at least one double-sided printed circuit board. The circuit board can have one layer or a plurality of layers connected with one another. Accordingly, the circuit board comprises a variable thickness.

The circuit board can comprise a plurality of shapes, e.g. a rectangular, square or block shape. The shape of the circuit board and, thus of the whole sensor arrangement, is adaptable to specific customer requirements. The same applies for the thickness of the circuit board. Thus, a very user-friendly sensor arrangement is provided which is flexible in use.

The circuit board has a top side and a bottom side. The bottom side is that side of the circuit board which is to be electrically connected to a user application. At least one first solder pad and at least one second solder pad are arranged on the bottom side. Moreover, at least one first solder pad and at least one second solder pad are arranged on the top side. The solder pads on the top side are electrically connected to the solder pads on the bottom side by means of vias.

The sensor arrangement further comprises at least one sensor device.

The sensor device comprises a temperature dependent electrical resistance. The sensor device may comprise an SMD (Surface Mounted Device) NTC (Negative Temperature Coefficient) or a Chip NTC component.

The sensor device comprises a first outer electrode and a second outer electrode which are adapted and arranged for direct electrical and mechanical connection with the first and second solder pad on the top side of the circuit board. The first and second outer electrode are arranged on an outer side of the sensor device, e.g. on a bottom side and/or on side surfaces of the sensor device.

The sensor device is mechanically and electrically connected directly to the top side of the circuit board. In particular, the sensor device/the outer electrodes of the sensor device is/are connected directly to the first and second solder pad on the top side of the circuit board. The sensor device may be soldered, press-fitted or wire bonded to the top side of the circuit board.

By the term “directly connected” it is meant that there is no further component/intermediate component, e.g. a metal pin/additional metal pads/terminals or the like, between the sensor device (in particular its outer electrodes) and the circuit board (in particular its solder pads) for establishing the connection. Accordingly, due to the specific structure of the sensor arrangement, at least one connection (e.g. connection between sensor device and intermediate component and/or connection between intermediate component and circuit board) can be reduced as compared to the state of the art. Thus, a cost-effective and compact sensor arrangement is provided.

The sensor arrangement further comprises an insulation. The insulation is arranged on a top side of the sensor arrangement. The sensor arrangement is adapted to measure the temperature of a surface which is in (direct) contact with the insulation.

A material of the insulation may comprise epoxy or a plastic material like thermoplastic or insulated glue. The insulation protects the sensor arrangement and, in particular, the sensor device from external influences.

The insulation envelops at least the sensor device on the top side of the circuit board completely. The sensor device is overmolded by the insulation. The bottom side of the sensor device is free from a material of the insulation. By encapsulating the soldered sensor device with the insulation material there will be no expose solder joint into the environment.

By usage of the double-sided printed circuit board, where an SMD NTC or Chip NTC are mounted into it and then protected with epoxy or plastic material as insulation, an optimized cost solution is given with the same features and function as it is the case for current designs according to the state of the art.

According to one embodiment, the insulation completely covers the top side of the circuit board. In other words, not only the sensor device but the whole top side including the sensor device is covered by the insulation. In this way, the top side of the sensor arrangement can be protected even better from external influences. Furthermore, a contact area for a surface whose temperature is to be measured is larger than with an insulation that only envelops the sensor device. This may also help to increase the accuracy of the sensor arrangement.

Further embodiments provide a method for producing a plurality of sensor arrangements is described. A sensor arrangement produced by the method may correspond to the sensor arrangement described above. All features described in connection with the sensor arrangement apply for the method, as well, and vice versa.

The method comprises the following steps:
A) Providing a substrate for obtaining a plurality of double-sided printed circuit boards. The respective circuit board has a top side and a bottom side, at least one first solder pad and at least one second solder pad being arranged on the top side and on the bottom side, respectively. A connection from top side solder pads to the bottom side solder pads will be through vias. The substrate has a thickness/height that is adaptable to specific customer requirements.
B) Electrically and mechanically connecting a plurality of sensor devices to the top side. The respective sensor device is soldered, press-fitted or wire bonded to the first and second solder pad on the top side of the respective circuit board.

The respective sensor device may comprise a SMD NTC or a chip NTC component. The respective sensor device comprises a top side and a bottom side, a first outer electrode and a second outer electrode being arranged on the bottom side of the respective sensor device.
C) Providing an insulating material to form an insulation. The insulation material comprises epoxy or plastic, like thermoplastic or insulated glue. The choice of material depends on temperature and thermal properties requirement.

The insulation envelops at least the respective sensor device completely. In particular, the respective sensor device is overmolded with the insulation material. Alternatively, the whole top side of the final (i.e. singulated) circuit board can be overmolded completely with the insulation material.
D) Separating the substrate into single parts for obtaining a plurality of final sensor arrangements. In particular, the molded circuit board is diced into single parts/broken on the scoring breaking point. A shape of the final sensor arrangement/the circuit board is adaptable to customer requirements. Accordingly, for example rectangular, square or block shape circuit boards can be singulated in this step.

The double-sided printed circuit board, which is used instead of a state of the art connector block, for example, is a cost effective solution and can be produced in one big sheet directly. In this way, the processing is simplified. Thus, a very effective and cost-efficient method is provided.

By adapting the shape and thickness of the circuit board and, thus, of the final sensor arrangement, a very user-friendly and flexibly usable sensor arrangement can be provided.

### BRIEF DESCRIPTION OF THE DRAWINGS

The drawings described below are not intended to be to scale. Rather, individual dimensions may be enlarged, reduced or even distorted for better representation. Elements which are similar or which perform the same function are designated with the same reference signs.

FIG. 1a shows a perspective bottom view of a sensor arrangement;

FIG. 1b shows a perspective top view of a sensor arrangement;

FIG. 2a shows a perspective view of a sensor arrangement according to a second embodiment during assembly;

FIG. 2b shows a perspective view of the sensor arrangement according to FIG. 2a during assembly;

FIG. 2c shows a perspective view of the finished sensor arrangement according to FIGS. 2a and 2b; and

FIG. 3 shows a perspective view of an exemplary sensor device.

### DETAILED DESCRIPTION OF ILLUSTRATIVE EMBODIMENTS

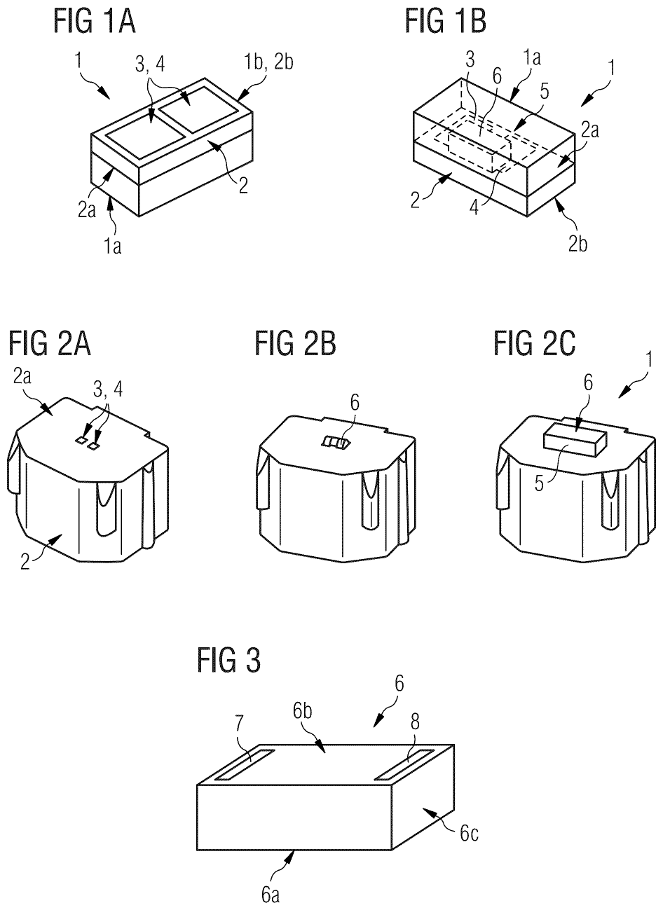

FIGS. 1a and 1b show a sensor arrangement 1. The sensor arrangement 1 is adapted for measuring a temperature, for example the temperature of a surface. The sensor arrangement 1 is a temperature sensor arrangement.

The sensor arrangement 1 comprises a top side 1a and a bottom side 1b. The bottom side 1b is that side of the sensor arrangement 1 which is electrically connected to an outside application when the sensor arrangement 1 is finally installed.

The top side 1a is that side which is in direct contact with the surface the temperature of which is to be measured once the sensor arrangement 1 has been finally installed.

The sensor arrangement 1 comprises a circuit board 2. The circuit board 2 is a double-sided printed circuit board 2. The circuit board 2 comprises a top side 2a and a bottom side 2b. The bottom side 2b of the circuit board 2 is also the bottom side 1b of the sensor arrangement 1. The top side 2a of the circuit board 2 is adapted and arranged to be directly mechanically and electrically connected to a sensor device 6, in particular a temperature sensor device 6 (see FIGS. 1b and 3).

A shape of the circuit board 2 can be varied based on a customer mounting situation. In this embodiment, the circuit board 2 comprises a rectangular shape but, of course, various shapes are conceivable, e.g. a square shape, a round shape, a block shape, etc. The circuit board 2 may comprise one single layer or a plurality of layers connected with each other. Thus, not only the shape but also a thickness of the circuit board 2 and, thus, of the whole sensor arrangement 1 is adaptable to specific customer requirements.

The circuit board 2 comprises first and second solder pads 3, 4. A first solder pad 3 and a second solder pad 4 are arranged on the top side 2a for direct electrical and mechanical connection with the sensor device 6. Moreover, a first solder pad 3 and a second solder pad 4 are arranged on the bottom side 1b, 2b for electrical connection of the sensor arrangement 1 with an outside application.

The connection to the outside application will be done through the solder pads 3, 4 with soldering, wire bonding or pin connection. An electrical connection between the solder pads 3, 4 on the top side 1a and the solder pads 3, 4 on the bottom side 1b, 2b is established by means of vias (not explicitly shown in the Figures).

The sensor device 6 (see exemplary sensor device 6 in FIGS. 1b and 3) comprises an SMD NTC sensor or a Chip NTC sensor device. The use of a SMDT NTC sensor device 6 or a chip NTC sensor device 6 depends on the R-T curve requirement. An NTC chip sensor device 6 will require additional means of connection like wire bonding or pin connection to connect one pole to the others.

The sensor device 6 has a top side 6a and a bottom side 6b as well as opposing side surfaces 6c. Connection elements, in particular outer electrodes (first outer electrode 7 and second outer electrode 8) are arranged on the bottom side 6b. In an alternative embodiment (not explicitly shown), the outer electrodes 7, 8 may be arranged on the opposing side surfaces 6c or on the top side 6a, for example.

The first outer electrode 7 is connected directly, e.g. soldered, press-fitted or wire bonded, to the first solder pad 3 on the top side 2a of the circuit board 2. The second outer electrode 8 is connected directly, e.g. soldered, press-fitted or wire bonded, to the second solder pad 4 on the top side 2a of the circuit board 2.

No intermediate component, e.g. a pin/terminal/metal layer, is arranged between the outer electrodes 7, 8 of the sensor device 6 and the solder pads 3, 4 of the circuit board 2.

The sensor device 6 shown in FIGS. 1b and 6 is only an exemplary embodiment of a sensor device 6 connected to the circuit board 2. Of course, all different kinds of SMD NTC or chip NTC sensor devices are conceivable.

The sensor device 6 is enclosed completely by an insulation 5 as can be gathered from FIGS. 1a and 1b. The sensor device 6 is overmolded by a material of the insulation 5. The insulation comprises a plastic material or epoxy.

In the embodiment according to FIGS. 1a and 1b, the insulation 5 also covers the top side 1a of the sensor arrangement 1 completely. In particular, the complete top side 1a of the sensor arrangement 1 including the sensor device 6 is overmolded by the insulation 5. This is to say that the sensor device 6 is arranged inside the sensor arrangement 1. In other words, the sensor device 6 is completely integrated in the sensor arrangement 1.

The sensor device 6 measures the temperature of a surface which is in contact with the insulation 5.

FIGS. 2a to 2c show a sensor arrangement 1 or intermediate states thereof according to a second embodiment.

The sensor arrangement 1 comprises a double-sided printed circuit board 2. In this embodiment, the circuit board 2 comprises a block shape. In particular, it has a greater thickness than the circuit board 2 shown in FIGS. 1a and 1b. The thickness of the circuit board 2 can be adapted to specific mounting situations by having a circuit board 2 with several layers, wherein the layers are connected to one another.

Again, the circuit board 2 comprises a first solder pad 3 and a second solder pad 4 on the top side 2a (FIG. 2a). The sensor device 6 as described in connection with FIGS. 1a, 1b and 3 is connected directly to the first solder pad 3 and the second solder pad 4, e.g. by means of soldering, press-fitting or wire bonding (FIG. 2b). No intermediate component such as a metal pin is arranged between the sensor device 6 and the circuit board 2.

The sensor device 1 may comprise an SMD NTC component or a chip NTC component. Moreover, the sensor device 6 is completely embedded/overmolded by the insulation 5 (FIG. 2c). By encapsulating the soldered sensor device 6, there is no expose solder joint into the environment.

In this embodiment, the insulation 5 only covers a part of the top side 2a of the circuit board 2 as can be gathered from FIG. 2c. In other words, the top side 2a of the circuit board 2 remains free from insulation material except for that region where the sensor device 6 is placed on the circuit board 2.

In the following, a method for producing a sensor arrangement 1, in particular a plurality of sensor arrangements 1, is described. Preferably, a sensor arrangement 1 as described above is produced by the method. All features described in connection with the sensor arrangement 1 thus apply also for the method and vice versa.

The method comprises the following steps:

In a first step A) a substrate is provided. The substrate constitutes a base material for a plurality of double-sided printed circuit boards 2 having a top side 2a and a bottom side 2b. The respective circuit board 2 comprises a first solder pad 3 and a second solder pad 4 arranged on the top side 2a and on the bottom side 2b, respectively.

In a next step B) a plurality of sensor devices 6 are electrically and mechanically connected directly to the top side 2a, in particular to the first and second solder pads 3, 4 on the top side 2a of the substrate. The sensor devices 6 are soldered, press-fitted or wire bonded to the solder pads 3, 4 (see FIG. 2a).

In a further step C), an insulating material, e.g. a plastic or an epoxy, is provided to form an insulation 5. The insulation 5 envelops at least the respective sensor device 6 completely (FIG. 2c). In an alternative embodiment, the insulation 5 envelops the complete top side 1a of the final (i.e. separated) sensor arrangement 1 (FIGS. 1a, 1b).

In a last step D) the substrate is separated into single parts for obtaining a plurality of final sensor arrangements 1.

The description of the objects disclosed herein is not limited to the individual specific embodiments. Rather, the features of the individual embodiments can be combined with each other in any way—as far as this makes technical sense.

What is claimed is:

1. A sensor arrangement comprising:
at least one double-sided printed circuit board, wherein the circuit board has a top side and a bottom side, at least one first solder pad and at least one second solder pad being arranged on the top side and on the bottom side, respectively;
at least one sensor device mechanically and electrically connected directly to the top side of the circuit board; and
an insulation enveloping at least the sensor device on the top side of the circuit board completely,
wherein the sensor arranged is configured to measure a temperature.

2. The sensor arrangement according to claim 1,
wherein the insulation covers completely the top side of the circuit board.

3. The sensor arrangement according to claim 1,
wherein the sensor device comprises a temperature dependent electrical resistance.

4. The sensor arrangement according to claim 1,
wherein the sensor device comprises a first outer electrode and a second outer electrode, which are in direct electrical and mechanical contact with the first and second solder pad on the top side of the circuit board.

5. The sensor arrangement according to claim 4,
wherein the first outer electrode and the second outer electrode are arranged at a bottom side and/or on opposing side surfaces of the sensor device, and wherein the bottom side of the sensor device is free from a material of the insulation.

6. The sensor arrangement according to claim 1,
wherein the first and second solder pads arranged on the bottom side of the circuit board are configured for electrically connecting the sensor arrangement to an outside application, and
wherein the first and second solder pads arranged on the top side of the circuit board are configured for electrically connecting the circuit board with the sensor device.

7. The sensor arrangement according to claim 1,
wherein the sensor device is soldered, press-fitted or wire bonded directly to the top side of the circuit board.

8. The sensor arrangement according to claim 1,
wherein the first and second solder pads arranged on the top side of the circuit board are electrically connected to the first and second solder pads on the bottom side by vias.

9. The sensor arrangement according to claim 1,
wherein the sensor device comprises an SMD NTC or a chip NTC.

10. The sensor arrangement according to claim 1,
wherein a material of the insulation comprises epoxy or plastic.

11. The sensor arrangement according to claim 1,
wherein an outer shape of the sensor arrangement is adaptable to specific customer requirements.

12. A method for producing a plurality of sensor arrangements, the method comprising:
providing a substrate for a plurality of double-sided printed circuit boards, wherein a respective circuit board has a top side and a bottom side, at least one first solder pad and at least one second solder pad being arranged on the top side and on the bottom side, respectively;
electrically and mechanically connecting a plurality of sensor devices to the top side;
providing an insulating material to form an insulation, wherein the insulation envelops at least the respective sensor device completely; and
separating the substrate into single parts for obtaining the plurality of sensor arrangements.

13. The method according to claim 12,
wherein providing the insulating material comprises overmolding at least the respective sensor device with the insulation material.

14. The method according to claim 12,
wherein providing the insulating material comprises completely overmolding the top side of the circuit board with the insulation material.

15. The method according to claim 12,
wherein the insulation material comprises epoxy or plastic.

16. The method according to claim 12,
wherein the sensor device is soldered, press-fitted or wire bonded to the first and second solder pad on the top side.
